(19) United States
(12) Patent Application Publication
(10) Pub. No.: US 2008/0186966 A1
(43) Pub. Date: Aug. 7, 2008

(54) Method for Ensuring the Accessibility of Communication Network Subscribers

(75) Inventor: Norbert Lobig, Darmstadt (DE)

Correspondence Address: BELL, BOYD & LLOYD, LLP, P.O. BOX 1135, CHICAGO, IL, 60690, US

(73) Assignee: Nokia Siemens Networks GmbH & Co KG, Munich (DE)

(21) Appl. No.: 11/886,237

(22) PCT Filed: Feb. 16, 2006
(86) PCT No.: PCT/EP06/60020

§ 371 Date: Sep. 13, 2007

(30) Foreign Application Priority Data
Mar. 15, 2005 (DE) 10 2005 011 882.8

(51) Int. Cl. H04L 12/28

(52) U.S. Cl. 370/390

(57) ABSTRACT

An individual accessibility profile specific to each subscriber is created when the communication connection is established, and a connection to the at least one communication terminal is established as required, according to the data stored in the accessibility profile, the information being supplied to the subscriber via connection when the subscriber is reached, and acknowledged by the subscriber on receipt thereof. Thus a subscriber is provided with information in the event of there being an imminent high level of danger or ecological catastrophe.

### CROSS REFERENCE TO RELATED APPLICATIONS

This application is the US National Stage of International Application No. PCT/EP2006/060020, filed Feb. 16, 2006 and claims the benefit thereof. The International Application claims the benefits of German application No. 102005011882.8 DE filed Mar. 15, 2005, both of the applications are incorporated by reference herein in their entirety.

### FIELD OF INVENTION

The present invention relates to ensuring the accessibility of communication network subscribers.

### BACKGROUND OF INVENTION

In the prior art, sirens are used to alert/warn the population of major hazards or environmental disasters such as fire, storm, flood, effects of accidents, armed conflicts, etc., information about the impending threat being communicated to the population via frequencies/tone sequences. The problem here, however, is that alerting by siren is not universally possible over a wide area, and even where it is provided in principle, e.g. in major cities, not everyone can be reached on a workplace or residence related basis. Moreover, as only a limited range of frequencies or tone sequences is available and it cannot be assumed that the population is familiar with them, it is evident that there are severe limitations to this kind of alerting/warning of the population.

The same applies to radio and television alerts/warnings, as these require that the relevant medium is being used at the time of the warning. However, even if this is the case, because of nationwide programming (i.e. users are not listening to the relevant local channel over which the warning is being transmitted) it is not guaranteed that the alert/warning will be received.

### SUMMARY OF INVENTION

To solve these problems, alternatives based on communication networks have been developed by the telecommunication network operators. These are proposals involving the broadcasting of announcements. However, even these provide no certainty as to whether the alert/warning has reached the intended recipient and has been received and understood by same. Thus in the case of pure recorded announcement services, for example, there is the problem that the subscriber has activated certain call processing features just when the alert is issued. However, through-connection of the call is no criterion for the announcement also having been received. If the subscriber is operating a service such as voice mail, simple absence greeting or local devices which are automatically activated after a certain number of rings (older FAX connections), the calling switch regards the call as having been through-connected, but the warning is spoken e.g. to the subscriber's recorded announcement service or recorded in a voice mail system. The subscriber is therefore deemed to have been warned, but this is de facto not the case.

Finally, these approaches are based on the no longer wholly correct assumption of a single local network operator whose local switch terminates all the lines of a certain region and covers same with corresponding local area codes. In the age of number portability and a large number of network operators this approach is problematic and possibly results in accessibility problems in higher-order network nodes.

The disadvantage of all the prior art methods is therefore that emergency services cannot actually assume that the alert/warning has been received and taken note of by the intended recipient. However, this would be vitally necessary in order to target assistance measures ultimately resulting in damage being avoided and lives being saved.

The object of the invention is to demonstrate a way of ensuring the accessibility of as many people as possible in order to be able to communicate efficiently when necessary.

This object is achieved by the features claimed in the independent claims.

The advantage of the invention is that the accessibility of the population for alerting/warning purposes is ensured by the provision of subscriber-specific accessibility profiles. This is possible, as almost every citizen of a civilized country now has access to a communications terminal of some kind. The alerting/warning concept takes account of the subscriber's individual behaviors and requirements. Thus, for example, a multilingual alert can be issued using subscriber-specific profile information and priorities. As there are a large number of foreign fellow citizens who cannot speak/understand the national language, this also enables existing language problems to be eliminated.

Another advantage of the invention is in generating confirmation that the warning has been received via the receiving subscriber terminal equipment. Acknowledgment of receipt of alarm information or the absence of such an acknowledgment is documented, thereby enabling assistance to be efficiently initiated.

Basically, with a concept of this kind short advance warning times are possible, no network blockages occur, and the method is independent of the network technology (TDM, IP), which ultimately means an economic use of the call processing resources. Destinations in mobile communication networks are likewise taken into account. Finally, the invention is not limited to this application alone. For example, the invention can likewise be used for advertising announcements, for attendance scanning for day release prisoners in the penal system or similar applications.

Easy implementation in existing systems is possible, as no functional modifications need to be undertaken in existing switching nodes.

### BRIEF DESCRIPTION OF THE DRAWINGS

The invention will now be explained in greater detail with reference to an example illustrated in the accompanying drawings in which:

FIG. 1 shows the creation of the subscriber lists for a plurality of media servers according to the invention,

FIG. 2 shows an example with numbers

### DETAILED DESCRIPTION OF INVENTION

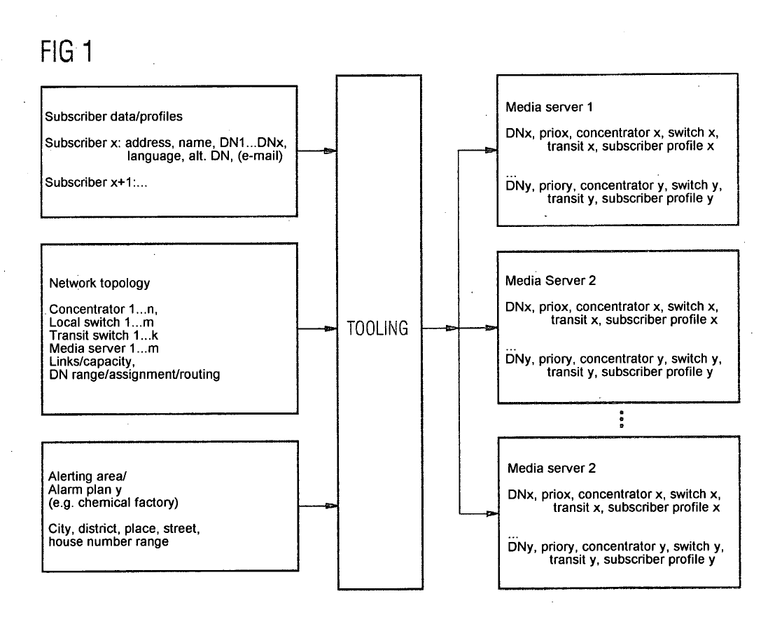

FIG. 1 shows how subscriber lists via which users of a communication network are to be alerted in the event of an emergency are created. It is provided according to the invention that an accessibility profile is created for each subscriber when a communication connection is installed. This profile must then be maintained for as long as the connection exists, i.e. the data stored here must be constantly updated (e.g. in event of a move). The accessibility profile consists of items of data which are representative of the identity and whereabouts of the subscriber. These can be, for example, directory number, name, place of residence, language, second residences, alternative directory numbers (neighbors, relatives, caretaker, etc.), cell phone number(s) if any, e-mail address, etc. The subscriber himself has access to part of the accessibility profile (e.g. via Internet (WEB), WAP (Wired Application Protocol), IVR access (Interactive Voice Response)). Thus he can himself perform updates in the case of subordinate data (backup directory numbers, etc.). From the subscribers' alarm profiles, the network operator creates subscriber lists for alerting regions, cities, districts of cities, flood plains, avalanche areas, etc. These can be generated as the result of official alarm planning via the subscriber address in the profile date (FIG. 1).

FIG. 1 also shows how discrete parts of the list of subscribers to be alerted are assigned to a plurality of regional media servers on or before the occurrence of the alarm. These processes are controlled by TOOLING software. For the further dissemination of alarm information to the subscribers, the conditions of the network topology (concentrators 1 . . . n, local switches (Ovst) 1 . . . m, transit switches 1 . . . , k, media servers 1 . . . m, connection paths/ capacities, DN (Directory Number) range/assignment/routing) are also taken into account. This is done by adapting, in the media servers, the traffic generated between the media servers and the subscribers to be alerted by same, to the bandwidths and signaling capacities of intervening switches and connection paths. This likewise applies to the interface conditions of subscriber concentrators (lines, ringing current generator power, etc.) or bandwidths of the subscriber access. For this purpose a maximum number of parallel calls per subscriber set is defined in the media servers.

In the event of an alarm, a media server has at its disposal the subscriber list intended for it in respect of said alarm. This list contains subsets of subscribers that can be reached via the same paths, each of said subsets being assigned a maximum number of parallel calls. Edited network topology data is therefore available to the relevant media server. The actual subscriber profile data can be stored on central databases and retrieved by the media servers as and when required.

When alerting is initiated, the media servers set up outgoing calls to the subscribers to be alerted and, when a connection has been established, play a current announcement specific to the alarm. This can advantageously take place by means of one-off generation of the user data stream and the use of broadcast mode for a subset of the subscribers to be alerted. Only the maximum permissible parallel calls not exceeding the maximum permissible transmission capacity of the trunks are set up in the direction of a subset.

The announcement must be heard in its entirety by the subscriber and ends with a request for an acknowledgment in the form of a DTMF input or a simple voice input which the media server waits for and, when it is received, clears down the connection again. Typical acknowledgments are:

“Yes (I have received the information)” or

“Yes/no (I will (not) leave the evacuation area)”

The media server makes a note of the acknowledgment input as evidence of alerting. If the subscriber is busy, cyclical or possibly multiple repetitions take place. If the subscriber is unobtainable, permanently busy or does not acknowledge, the current subscriber-specified backup strategy (alternative numbers, SMS, e-mail) is adopted.

In the simplest case the alerting announcement is a broadcast announcement which is played repeatedly and into which the subscriber is switched midway through when he takes the call. At the end of the announcement the subscriber is requested to enter an acknowledgment (DTMF input or voice input):

When you have heard the announcement in full, please press 1 or say “yes”). This takes place simultaneously for all the connected subscribers of the broadcast group of a language. Precisely at the time when the input request is complete, an identifier logic which receives the input is connected to all the back channels. If a subscriber gives a positive/negative acknowledgment, this is noted in a ticket (CDR), the connection is cleared down, and the subscriber is deemed to have been alerted. If after several repetitions of the announcement no acknowledgment is received, the connection is likewise cleared down, and the subscriber is deemed not to have been alerted. This results in the application of the specified individual backup strategy.

In respect of the resource requirement, a media server advantageously has a plurality of equidistantly time-spaced broadcast announcements of groups of subscribers of the same maximum number and allocates the identifier resources for the time in which the input is awaited, thereby increasing the performance of the media servers many times over. If a machine (e.g. a voice mailbox) is reached, the latter is highly unlikely to answer by chance with the input expected from the subscriber at the end of the announcement. This eliminates the possibility of a subscriber being deemed to have been alerted when this is not in fact the case.

The acknowledgment information is used as the basis for any necessary special action by emergency services and can be visualized with any filtering. The media server monitors the success of its calls toward subscribers of a certain direction and adjusts down the traffic generated by it if the through-connection rate becomes poor. If therefore an alert is to be issued in the busy hour or disturbances are currently present in the network, the media server notices this implicitly and adjusts its traffic volume down.

Alerting priorities can be set individually for each subscriber. A typical application would be the circumstance that people living in the immediate danger area of a chemical factory are warned more quickly than others.

If a subscriber is busy, the media server can initiate a “completion of calls to busy subscriber”, perform timing or access the subscriber via MLPP as a priority caller if the network infrastructure supports these features. As an alternative to simple voice input, which still allows some slight doubt that the correct subscriber has been reached, complete authentication as an alternative to DTMF/voice input can be performed (entering a PIN, password, speaker recognition).

The method can likewise be used in the IP environment. For a pure IP environment with complex coding of the user data stream (e.g. in accordance with ITU-T G.729), identifier resources can be completely dispensed with when using numerical inputs. Here the inputs may arrive from the distant end by signaling or in accordance with RFC 2833. This means that a very large number of broadcast groups can be set up whose time offset would be very slight so that the impression of the subscriber switched to an ongoing announcement is eliminated.

The associated charge tickets permit offline charging for the alerting service.

It is basically possible for the media servers to interrogate presence servers as well as HLR (Home Location Register) information if appropriate interfaces are present. This may be accompanied by extended accessibility, or else the media servers detect on the basis of the associated topology information itself that the subscriber (e.g. because of absence in the disaster area) can no longer be urgently informed at all. These findings can also be provided in ticket form for documentation.

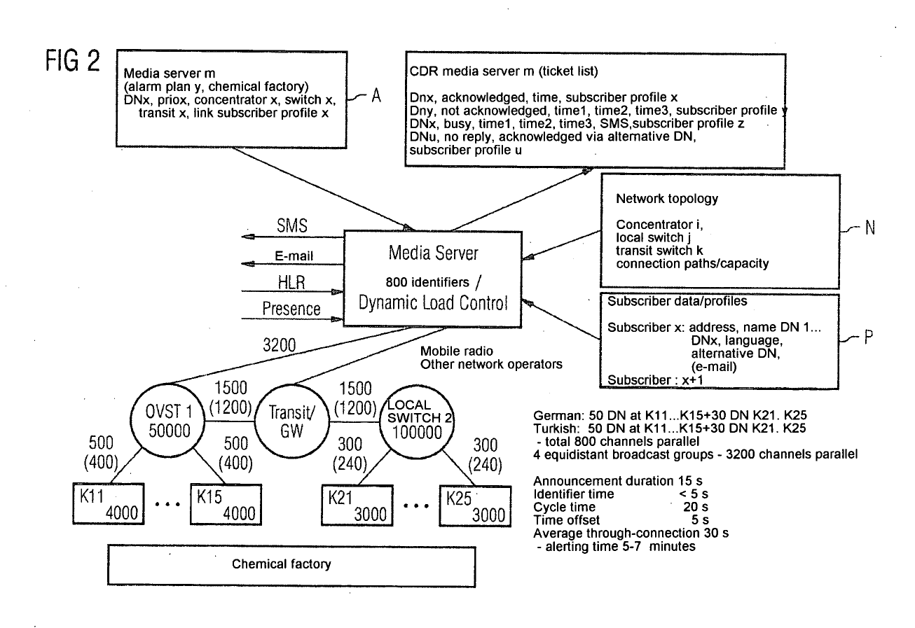

FIG. 2 puts specific numbers to the above described example. The media server m is accordingly shown as the central instance in the network. FIG. 2 also shows an alarm list A of the media server m, as generated by the alarm plan y for a chemical factory. As a typical data record, directory numbers (DNx), priorities (priox), concentrators, switches (VST x), transit offices, as well as connection paths (links) are shown. The media server m has access to said alarm list A.

Also shown are lists N, P to which the media server m likewise has access. The first contains information relating to the network topology. This means that information concerning concentrators, local switches, transit switches as well as all or certain links/capacities of the network are stored here. The other list P contains information about subscriber data and subscriber profiles. Examples include directory number, address, name, alternative numbers under which the subscriber can be reached, language, or e-mail address.

On the basis of its access to the lists A, N, P, the task of the media server m is now to create a strategy with which the subscribers specified in the list A can be informed as quickly as possible. For this purpose the lists are interlinked. For example, the media server m obtains from the alarm plan y of a chemical factory (list A) which subscribers are in danger in the immediate vicinity of the chemical factory. This information is correlated with the information in list N, by means of which the network topology in the danger area is determined. Finally the data of the lists A, N are correlated with the data of the list P, by means of which a profile of the subscribers affected is assigned.

It is assumed, for example, that the media server m determines as a result of this linking that 50% of the subscribers affected at the concentrators K11 to K15 and 50% of the subscribers affected at the concentrators K21 to K25 are German speakers. It is additionally determined, by way of example, that 50% of the subscribers affected at the concentrators K11 to K15 and 50% of the subscribers affected at the concentrators K21 to K25 are Turkish speakers.

It is further assumed, for example, that the media server m also determines as a result of this linking that it simultaneously informs 50 affected subscribers at the concentrators K11 to K15 and 30 affected subscribers at the concentrators K21 to K25 at a time in German. It is additionally determined, for example, that 50 affected subscribers of the concentrators K11 to K15 and 30 affected subscribers of the concentrators K21 to K25 are simultaneously informed at a time in Turkish. This results in a total of 800 channels which are operated in parallel and, assuming German and Turkish announcement texts of equal length, simultaneously reach the time of subscriber acknowledgment.

On the basis of the network topology, the media server m detects that a total of 3200 channels to the local switch Ovst 1 are available to it. For example, let it further be assumed that said local switch has 50000 subscribers connected, of which 4000 are to be alerted at the concentrators K11 to K15. From the local switch Ovst 1 there exist as real lines 500 channels to the concentrators K11 to K15. As 800 channels in total are to be operated in parallel, the media server m switches 4 time-equidistant broadcast groups so that a total of 3200 channels are operated. Let it also be assumed, for example, that the announcement duration is 15 seconds. Let the identifier time be specified as less than 5 seconds which means that a called subscriber can respond in this time. This means altogether a cycle time of 20 seconds with a time offset of 5 seconds. If the average through-connection time is assumed to be 30 seconds, this produces a total alerting time for the subscribers connected to the concentrators K11 to K15 and K21 to K25 of 5 to 7 minutes.

As a result of the subscriber contacting attempts, CDR tickets are created by the media server m (ticket list). It is detailed here, for example, that a subscriber DNx has acknowledged the message. This is recorded as well as the time and the relevant subscriber profile of that subscriber. Also typically recorded here is a subscriber DNy who has not acknowledged and who has already been unsuccessfully contacted at three different times in the course of a backup strategy. As indicated in FIG. 2, the backup strategy can be undertaken via SMS or e-mail and information to be issued in the CDR ticket can be made more precise by including HLR or presence server information.

Finally, attention is drawn to the fact that the media server m can perform dynamic load control. This means that in the case of an already existing high-traffic load, the additional load produced between the media server and the concentrators is dynamically detected as excessive and then adjusted down to a lower throughput rate. If the network load capacity then so permits, the load generated by the media server is dynamically increased within the framework of the available capacities of the network. This ensures that the activity of the media server in respect of the current alert never exceeds the framework of the performance provided by the network and system-related network blockages due to bulk traffic are prevented in particular directions.

Although the inventive method and the inventive apparatus have been described according to the above example in terms of the transmission of alarm information acknowledged by the subscriber, the invention is not limited to this application alone.

Thus, for example, the invention can likewise be used for advertising announcements, for attendance scanning for day release prisoners in the penal system or similar applications.

1.-14. (canceled)

15. A method for transmitting information to a large number of communication network subscribers accessible via at least one communication terminal, comprising:
storing a subscriber-specific accessibility profile for each subscriber; and
establishing a connection is to the at least one communication terminal according to the data stored in the accessibility profile for the respective subscriber.

16. The method as claimed in claim 15, wherein the subscriber-specific accessibility profile comprises data which is representative of an identity or a primary places of residence of the respective subscriber.

17. The method as claimed in claim 15, wherein the data in the subscriber-specific accessibility profile is constantly updated.

18. The method as claimed in claim 15, wherein the subscriber-specific accessibility profile comprises at least one indicia selected from the group consisting of a directory number, an e-mail address, an item of equivalent destination address information of a communication network, a priority sequence, a time-related accessibility assignments within a directory number, a destination address information or an indication of the national language to be used for supplying the information to respective subscriber.

19. The method as claimed in claim 15, further comprising receiving an the acknowledgment from the respective subscriber.

20. The method as claimed in claim 19, wherein the acknowledgment from the respective subscriber is in the form of a tone signal, a numerical input, a voice input, an SMS or an e-mail.

21. The method as claimed in claim 15, wherein the information supplied to the subscriber is a warning of impending danger, an advertising announcement or an attendance scanning for day release prisoners in the penal system.

22. The method as claimed in claim 15, wherein when the subscriber in not reached via the connection the method further comprising:
establishing a further connection a further communication terminal specified by the profile; or
sending message based informing out without connection relation.

23. The method as claimed in claim 19, further comprising:
storing data pertaining to information the respective subscriber, the data including a status, a time, and a type of accessibility alternatives used; and
providing the stored data to a network operator.

24. The method as claimed in claim 23, wherein the status is a circumstance of successfully or unsuccessfully informing the respecting subscriber.

25. The method as claimed in claim 23, wherein the provided data is used for at least one of subsequent processing, charging, filtering, and visualization.

26. A program for processing subscriber data records containing at least geographical data of the whereabouts of communication network subscribers, accessibility information in the form of directory numbers, e-mail addresses and/or equivalent communication network destination address information as well as priority information in respect of the preferred type of accessibility, the program when executed on a processor provides the steps of:
defining a geographical definition of at least one relevant area via an input; and
defining a network topology information including a plurality of media servers and respective network connection via an input;
processing the subscriber data records such that each subscriber data record of a subset of subscriber data records of subscribers potentially affected is assigned to just one media server, and
wherein the assignment of the subscriber data records of potentially affected subscribers to the media servers is performed to provide:
an optimum capacity utilization of the media servers,
a low traffic loading of the network by playing a specified announcement or a dialog to the set subscribers assigned to a media server, and
a shortest anticipated time until a last potentially affected subscriber is informed.

27. The program as claimed in claim 26, wherein the relevant area is defined by at least one indicia including a postal addresses of a country, a rural district, a county, a city, a district of a city, a street, and a set of local area codes of a communication network.

28. The program as claimed in claim 26, wherein the network topology information includes a number and a configuration of subscriber concentrators, local switches, media servers, transit nodes and gateways, capacities of links and network nodes, and an assignment of directory numbers to subscriber concentrators or gateways.

29. A media server incorporating means of defining a maximum number of parallel calls per subscriber set, comprising:
a communications traffic generated between at least one media server and the subscribers to be alerted by same such that a bandwidth, a signaling capacity of intervening switches as well as the links and interface conditions of subscriber concentrators or a bandwidth of the subscriber access are not exceeded.

30. The media server as claimed in claim 29, further comprising a means of evaluating an acknowledged information.

31. The media server as claimed in claim 30, further a means of creating data records on the basis of the acknowledged information.
